(19) United States
(12) Patent Application Publication
(10) Pub. No.: US 2019/0227495 A1
(43) Pub. Date: Jul. 25, 2019

(54) Container Accessory Timer Attachment

(71) Applicant: Frank Marinello, JR., Brick, NJ (US)

(72) Inventor: Frank Marinello, JR., Brick, NJ (US)

(21) Appl. No.: 15/878,917

(22) Filed: Jan. 24, 2018

(51) Int. Cl. G04F 1/00; G04F 3/06

(52) U.S. Cl. CPC G04F 1/005; B65D 2203/00; G04F 3/06

(57) ABSTRACT

This accessory has adjustable elasticized straps, used to attach it on various types of containers; it contains a digital tinier encased in a magnifying plastic shell. When the timer shell cover is press down it resets the timer to zero and begins to track elapsed time in minutes, hours and days. This accessory has any number of uses, for example someone taking medication can determine the last time they took their medication, by resetting the timer on the attached accessory, each time they take a dosage. This can lessen the possibility of under or over dosing medication. Another example is on a beverage container, when the product is opened for the first time, the timer on the attached accessory is set to zero and begins to track elapsed time. By tracking its age after opening, it lessens the possibility of someone consuming a product past its recommended useful life.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This utility invention is related to tracking the age of contents stored in a container, for example, but not limited to being used on: prescriptions, wine, baby formula or mother's milk and other substances or products stored in a container. To expand on one potential application and problem it resolves; medications can inadvertently be taken too much or too little, because of an individual's potential to forget the last time they took a medicine.

Even though medications come with printed labels, telling the user how often to take a prescribed medication, it may be difficult for the person taking the medication to remember the last time it was taken, because often times one day blends into another and for elderly people there is a greater chance of forgetfulness. There are a number of sophisticated pill container products on the market today; to track how many times a day a medication was taken, to remind a person of how often they should take their medication, by send electronic messages regarding the taking of pills and so on. These products are often too sophisticated for an average person to program and maintain, expensive to purchase and require a great deal of time to maintain. Given the majority of prescription pills are used by the elderly, this is neither feasible nor efficient given their limited incomes and technology expertise.

In conclusion, since the options available to consumers today are both relatively expensive and too sophisticated to maintain on an ongoing basis, they are perhaps discarded and not used for very long.

The Container Accessory Timer Attachment is comprised of a simplistic combination of proven technologies and will provide an inexpensive alternative to the above mentioned options available to consumers today for this purpose. Now with only the press of a button on the attached accessory each time they take medication, it becomes possible to determine when they last took a dosage of medication. Additionally, since the Container Accessory Timer Attachment can be produced inexpensively, it can be employed on any number of prescriptions for the same purpose.

### BRIEF DESCRIPTION OF THE DRAWINGS

The drawing provided for this invention constitutes a specification and, the embodiment of the product, which may be embodied in various forms sizes and shapes. The aspects of this drawing show, for example: a timer containing only three classifications; however it may contain four counter classifications, which only depends upon the variety chosen for depiction. Dimensions may be exaggerated or enlarged to facilitate a better understanding of the invention, but do not limit its potential appearance in operation.

FIG. 1: depicts the top of the invention, which incorporates a medallion shape for illustration purposes only, timer in minutes hours and days, magnifying lens, elasticized straps and strap adjusters.

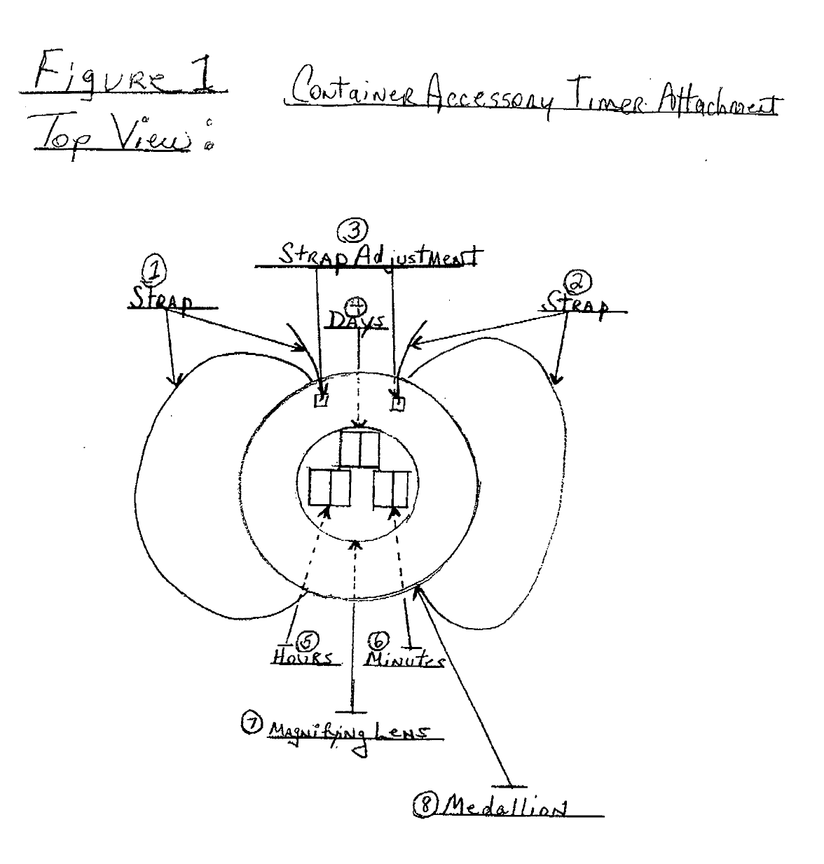

FIG. 2: depicts the bottom of the invention, which incorporates a medallion shape for illustration purposes only, elasticized straps and the timer on and off switch.

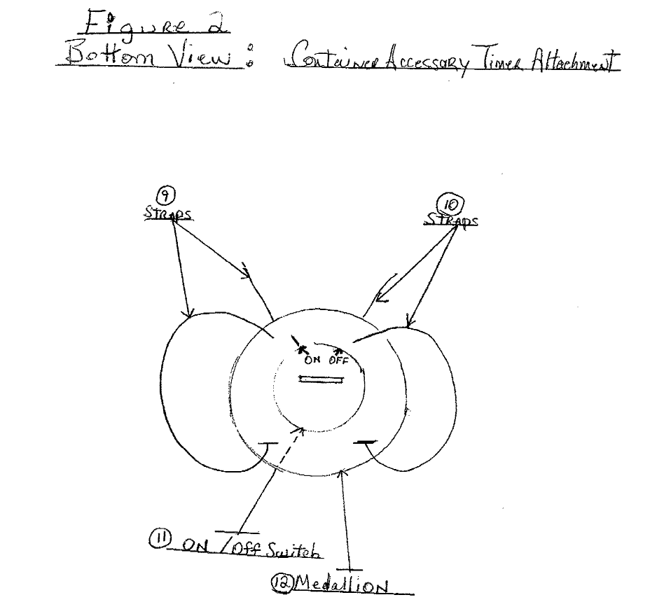

### BRIEF SUMMARY OF THE INVENTION

An accessory attachment with a built in timer and elasticized straps that can be adjusted to fit any variety of product containers. The digital timer can be turned ‘on’ or ‘off’ with simple operation when not in use, the elasticized straps are adjustable, so the accessory timer attachment can be used and reused on any various of product containers.

When the magnified digital timer cover shell is pressed down, it begins to measure elapsed time in minutes, hours and days starting at zero. Since the digital timer and its battery are sealed within the accessory it a safe addition to any type of container or bottle.

Unlike timers built into products, which are usually made for one specific purpose, are expensive and sold together as a single entity with product, this accessory is inexpensive and a consumer can purchase it for an variety of uses and affix them to multiple products throughout their home.

### BRIEF SUMMARY OF THE INVENTION

A container accessory with a built in timer and straps that can be adjusted to fit any variety of containers. The digital timer can be turned ‘on’ or ‘off’ with simple operation. The elasticized straps are adjustable, so the container accessory can be employed for various uses and reuses.

When the digital timer magnifying cover shell is pressed down, it begins to measure elapsed time in minutes, hours and days starting at zero. Since the digital timer and its battery are sealed in the accessory it a safe addition to any type of container or bottle.

Additionally, since the Container Accessory Timer Attachment can be made inexpensively, a consumer can purchase Container Accessory Timer Attachments for various uses throughout their home.

### DETAILED DESCRIPTION OF THE PREFERRED EMBODIMENTS

Detail descriptions of the preferred embodiment are provided herein. It is to be understood, however, that this invention may be embodied in various forms to fit containers. Therefore, specific details disclosed herein are not to be interpreted as limiting, but rather as a basis for the claims and as a representation to explain how to employ this utility invention on virtually any appropriate container or in any manner.

In broad terms this new utility integrates a combination of simplistic proven products that are mass produced today, to create a new utility with an unlimited number of uses, because it can be produced inexpensively, it can be used and reused for various purposes by simply attaching it onto various types of containers.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by its potential uses within its documentation.

1. (canceled)

2. (canceled)

3. (canceled)

4. (canceled)

5. (canceled)

6. Container Accessory Timer Attachment's digital timer cover shell has a transparent magnifying window used for viewing of elapsed time, when pressed down it resets the timer to zero.

7. Container Accessory Timer Attachment has adjustable elastic straps made in various sizes and shapes, to attach it onto any number of products for a variety of uses, not limited by the wording with in this document.

8. Container Accessory Timer Attachment's digital timer and extended life battery are sealed within the solid plastic medallion casing.
